(19) United States
(12) Patent Application Publication
(10) Pub. No.: US 2026/0367233 A1
(43) Pub. Date: Nov. 19, 2026

(54) INTERNET OF THINGS DEVICE WITH RANGING CAPABILITY AND METHOD THEREOF

(71) Applicant: Xiamen PVTECH Co., Ltd., Xiamen (CN)

(72) Inventors: CHENGQUAN XU, Xiamen (CN); BANG ZOU, Xiamen (CN); FUXING LU, Xiamen (CN)

(21) Appl. No.: 19/672,752

(22) Filed: May 11, 2026

(30) Foreign Application Priority Data
May 15, 2025 (CN) 202510625693.1

(51) Int. Cl. G01S 11/06

(52) U.S. Cl. CPC G01S 11/06

(57) ABSTRACT

An internet of things (IoT) device with ranging capability includes a Bluetooth module and a control module. The control module is connected to the Bluetooth module and switches the communication channel of the Bluetooth module based on a Bluetooth channel hopping mechanism, such that the Bluetooth module receives a plurality of broadcast signals from another IoT device over a plurality of communication channels. The control module calculates the received signal strength indication (RSSI) value of each of the broadcast signals, perform a filtering algorithm based on the RSSI values of the broadcast signals to obtain an updated RSSI value, and calculate the distance between the control module and another IoT device based on the updated RSSI value.

### TECHNICAL FIELD

The disclosure relates to an internet of things (IoT) device, in particular to an IoT device with ranging capability. The disclosure further relates to the ranging method of the IoT device.

### BACKGROUND

Currently available ranging approaches based on received signal strength indication (RSSI) primarily rely on a Bluetooth device periodically transmitting broadcast signals containing device information of the Bluetooth device. During propagation of the broadcast signals, a signal strength received at a receiving end gradually attenuates. The receiving end attempts to estimate the distance between the receiving end and the Bluetooth device by analyzing variations in the signal strength.

However, the currently available ranging approaches still suffer from various deficiencies. For example, Bluetooth communication channels are susceptible to significant channel interference and contamination. When a large number of other Bluetooth devices or other interference sources are present in the same communication channel, normal reception of the broadcast signals may be adversely affected, which may result in inaccurate measurement of the received signal strength indication. Such interference sources may originate from electromagnetic waves generated by other electronic devices.

### SUMMARY

One embodiment of the disclosure provides an internet of things (IoT) device with ranging capability includes a Bluetooth module and a control module. The control module is connected to the Bluetooth module and switches the communication channel of the Bluetooth module based on a Bluetooth channel hopping mechanism, such that the Bluetooth module receives a plurality of broadcast signals from another IoT device over a plurality of communication channels. The control module calculates the received signal strength indication (RSSI) value of each of the broadcast signals, perform a filtering algorithm based on the RSSI values of the broadcast signals to obtain an updated RSSI value, and calculate the distance between the control module and another IoT device based on the updated RSSI value.

Another embodiment of the disclosure provides a ranging method for an IoT device, which includes the following steps: switching, by a control module, a Bluetooth module based on a Bluetooth channel hopping mechanism, such that the Bluetooth module receives a plurality of broadcast signals from another IoT device over a plurality of communication channels; calculating, by the control module, the received signal strength indication (RSSI) value of each of the broadcast signals; performing, by the control module, a filtering algorithm based on the RSSI values of the broadcast signals to obtain an updated RSSI value; and calculating, by the control module, the distance between the control module and the another IoT device based on the updated RSSI value.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a block diagram of a lighting system in accordance with a first embodiment of the disclosure.

FIG. 2 is a block diagram of an internet of things (IoT) device with ranging capability in accordance with the first embodiment of the disclosure.

FIG. 3 is a first schematic view of a filtering algorithm of the IoT device with ranging capability in accordance with the first embodiment of the disclosure.

FIG. 4 is a second schematic view of the filtering algorithm of the IoT device with ranging capability in accordance with the first embodiment of the disclosure.

FIG. 5 is a third schematic view of the filtering algorithm of the IoT device with ranging capability in accordance with the first embodiment of the disclosure.

FIG. 6 is a flow chart of a ranging method for an IoT device in accordance with a second embodiment of the disclosure.

FIG. 7 is a flow chart of a ranging method for an IoT device in accordance with a third embodiment of the disclosure.

FIG. 8 is a flow chart of a ranging method for an IoT device in accordance with a fourth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

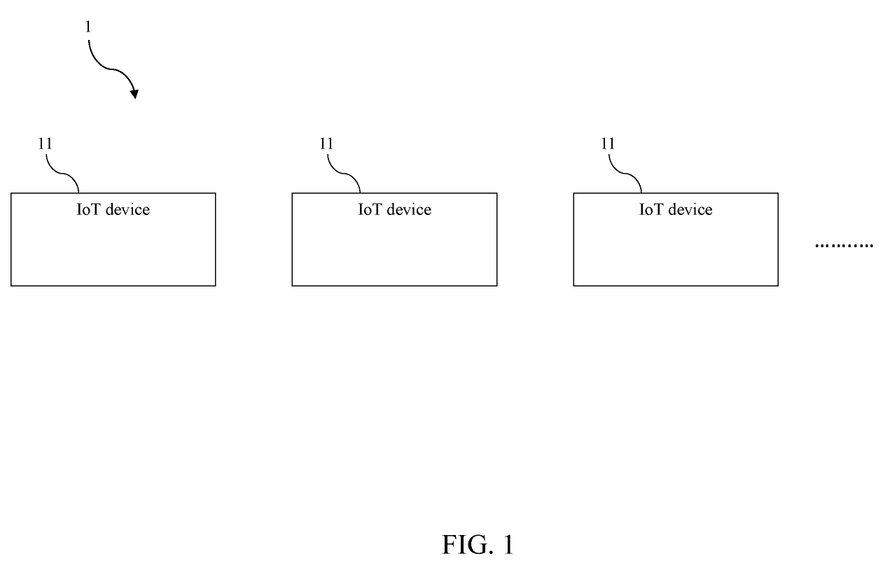

Please refer to FIG. 1, which is a block diagram of a lighting system in accordance with a first embodiment of the disclosure. As shown in FIG. 1, the lighting system 1 includes a plurality of Internet of Things (IoT) devices 11, and the IoT devices 11 are capable of communicating with one another. In this embodiment, the IoT device 11 may be a lighting device. In another embodiment, the IoT device 11 may also be a sensing device (such as a microwave sensing device or an infrared sensing device) or various household appliances.

The embodiment just exemplifies the disclosure and is not intended to limit the scope of the disclosure; any equivalent modification and variation according to the spirit of the disclosure is to be also included within the scope of the following claims and their equivalents.

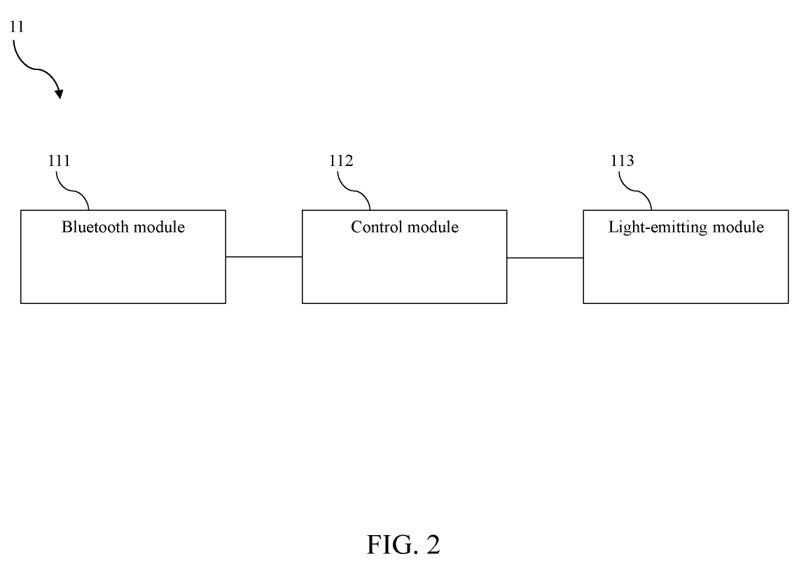

Please refer to FIG. 2, which is a block diagram of an IoT device with ranging capability in accordance with the first embodiment of the disclosure. As shown in FIG. 2, the IoT device 11 includes a Bluetooth module 111, a control module 112, and a light-emitting module 113. The control module 112 is connected to the Bluetooth module 111 and the light-emitting module 113. In one embodiment, the control module 112 may be a microcontroller (MCU). In another embodiment, the control module 112 may be a central processing unit (CPU), an application-specific integrated circuit (ASIC), a field programmable gate array (FPGA), or other similar components. In one embodiment, the light-emitting module 113 may be a light-emitting diode (LED). In another embodiment, the light-emitting module 113 may also be a light bulb, a fluorescent lamp, or the like.

The control module 112 switches the communication channel of the Bluetooth module 111 based on a Bluetooth channel hopping mechanism, such that the Bluetooth module 111 receives a plurality of broadcast signals Bs1 to Bsn transmitted from another IoT device 11 over multiple communication channels. Any two IoT devices 11 may perform the same mechanism. The control module 112 then calculates RSSI values of the broadcast signals Bs1 to Bsn, performs a filtering algorithm based on the RSSI values of the broadcast signals Bs1 to Bsn to obtain an updated RSSI value, and calculates the distance between the control module and the IoT device 11 (which transmits the broadcast signals Bs1 to Bsn) based on the updated RSSI value. The filtering algorithm is a moving average filtering algorithm, a median filtering algorithm, or a Kalman filtering algorithm.

Through the above optimized RSSI calculation mechanism, the IoT device 11 can rapidly calculate the distance between itself and another IoT device 11. Accordingly, the IoT device 11 can satisfy actual requirements.

In addition, after obtaining the distance between the control module 112 and another IoT device 11, the control module 112 may further dynamically adjust a ranging period and a hopping speed based on the distance. The control module 112 may perform the adjustment according to a plurality of distance threshold values. For example, when the distance is lower than a first threshold value (3 meters), the control module 112 sets the ranging period to 100 ms and performs the Bluetooth channel hopping mechanism at a highest hopping speed. When the distance is between the first threshold value (3 meters) and a second threshold value (10 meters), the control module 112 sets the ranging period to 300 ms and performs the Bluetooth channel hopping mechanism at a medium hopping speed. When the distance is greater than the second threshold value (10 meters), the control module 112 sets the ranging period to 500 ms and performs the Bluetooth channel hopping mechanism at a lowest hopping speed. Accordingly, when the distance between the control module 112 and another IoT device 11 is relatively short, the control module 112 performs high-frequency sampling to improve accuracy. When the distance is relatively long, the control module 112 performs low-frequency sampling to reduce power consumption.

In addition, the control module 112 may further calculate the variance of the RSSI value of the broadcast signal of each communication channel. When the variance of the RSSI values of the broadcast signal of any communication channel is greater than or equal to a first variance threshold value, the control module 112 excludes the RSSI values of the broadcast signal of the communication channel. For example, the variance threshold value is 6 dB. The RSSI value of the broadcast signal Bs1 of the first communication channel are −40, −60, and −45. The control module 112 calculates the variance of the RSSI value of the broadcast signal Bs1 as 68.89, which is greater than the first variance threshold value. At this time, the control module 112 excludes the RSSI value of the broadcast signal Bs1 of the first communication channel and does not use the RSSI value to perform the filtering algorithm. The RSSI value of the broadcast signal Bs2 of the second communication channel are −50, −51, and −52. The control module 112 calculates the variance of the RSSI value of the broadcast signal Bs2 as 0.67, which is less than the first variance threshold value. At this time, the control module 112 retains the RSSI values of the broadcast signal Bs2 of the second communication channel. The first variance threshold value may be adjusted according to actual requirements. The above mechanism can effectively exclude communication channels affected by interference so as to improve calculation accuracy.

The embodiment just exemplifies the disclosure and is not intended to limit the scope of the disclosure; any equivalent modification and variation according to the spirit of the disclosure is to be also included within the scope of the following claims and their equivalents.

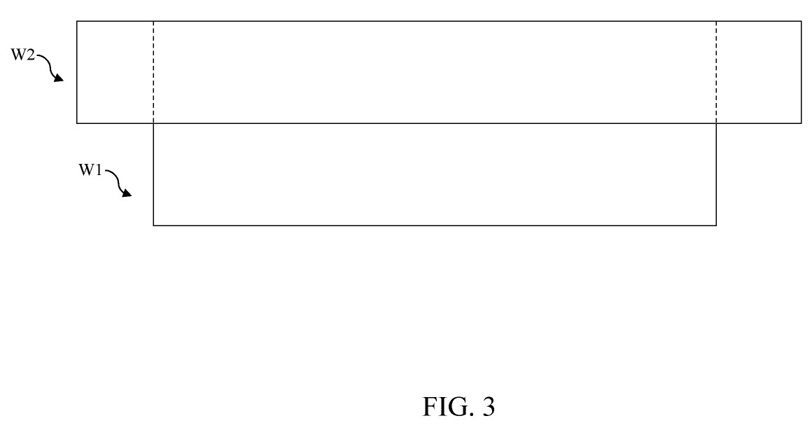

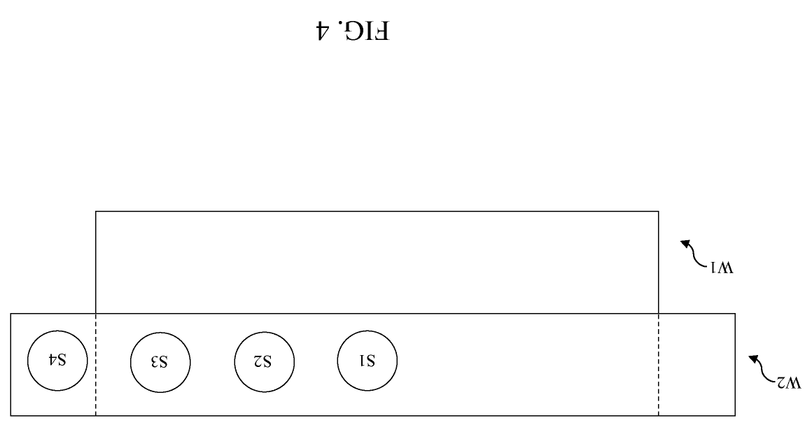

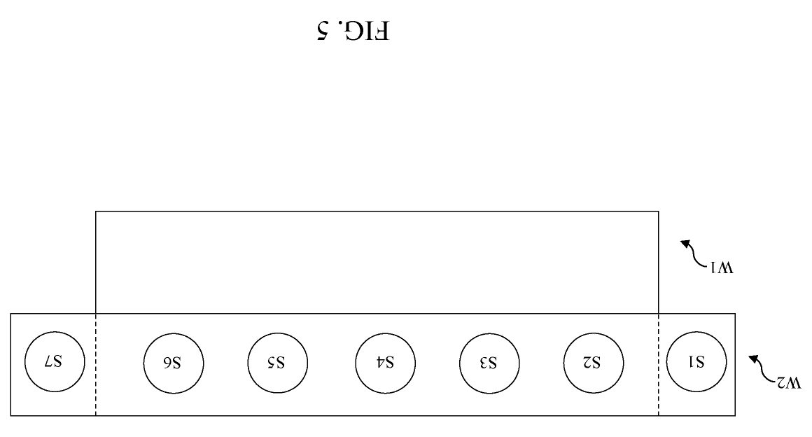

Please refer to FIGS. 3,4 and 5,3. is a first schematic view of a filtering algorithm of the IoT device with ranging capability in accordance with the first embodiment of the disclosure. FIG. 4 is a second schematic view of the filtering algorithm of the IoT device with ranging capability in accordance with the first embodiment of the disclosure. FIG. 5 is a third schematic view of the filtering algorithm of the IoT device with ranging capability in accordance with the first embodiment of the disclosure. As shown in FIG. 3, the control module 112 executes the filtering algorithm to establish a filtering window W1 and a sampling window W2 larger than the filtering window W1, and processes the RSSI values of the broadcast signals Bs1 to Bsn according to the filtering window W1 and the sampling window W2 to obtain an updated RSSI value. The size of the filtering window W1 and the size of the sampling window W2 may be appropriately adjusted and are not limited to those disclosed in the present embodiment.

As shown in FIG. 4, when the RSSI values S1 to Sn of the broadcast signals Bs1 to Bsn do not fill the sampling window W2, the control module 112 calculates the average value of the RSSI values of the broadcast signals Bs1 to Bsn, and calculates the distance between the control module 112 and the IoT device 11 (which transmits the broadcast signals Bs1 to Bsn) according to the average value.

For example, when the number of the broadcast signals Bs1 to Bs4 is four, the sampling window W2 is not filled. At this time, the control module 112 calculates the average value of the RSSI values S1 to S4 of the broadcast signals Bs1 to Bs4, and calculates the distance between the control module 112 and the IoT device 11 (which transmits the broadcast signals Bs1 to Bsn) according to the average value.

As shown in FIG. 5, when the number of the broadcast signals Bs1 to Bs7 is seven, the sampling window W2 is filled. At this time, the control module 112 removes the maximum value S1 and the minimum value S7 from the RSSI values S1 to S7 of the broadcast signals Bs1 to Bs7 to obtain updated data, calculates the average value of the updated data, and calculates the distance between the control module 112 and the IoT device 11 (which transmits the broadcast signals Bs1 to Bsn) according to the average value.

In addition, the control module 112 may calculate the above-mentioned average value by using a weighted average algorithm. The control module 112 may assign corresponding weights according to the variance of the RSSI value of the broadcast signal of each communication channel and a plurality of variance threshold values. Thereafter, the control module 112 calculates the above-mentioned average value according to the RSSI values and the corresponding weights of these communication channels by using the weighted average algorithm.

For example, the control module 112 may assign corresponding weights to the communication channels according to the variances of the RSSI values of the broadcast signals of the communication channels, a first variance threshold value, and a second variance threshold value. The first variance threshold value is greater than the second variance threshold value. For example, the first variance threshold value is 6 dB, and the second variance threshold value is 3 dB. When the variance of the RSSI value of the broadcast signal Bs1 of the first communication channel is 5 dB, which is between the first variance threshold value and the second variance threshold value (3 to 6 dB), the control module 112 sets the weight of the first communication channel as a first weight. When the variance of the RSSI value of the broadcast signal Bs2 of the second communication channel is 2 dB, which is less than or equal to the second variance threshold value (≤3B), the control module 112 sets the weight of the second communication channel as a second weight. The second weight is greater than the first weight. For example, the first weight is 0.6 and the second weight is 1. The control module 112 multiplies the RSSI value of each communication channel by the corresponding weight to obtain a first calculated value, calculates the sum of the first calculated values of all communication channels to obtain a second calculated value, and calculates the sum of the weights of all communication channels to obtain a third calculated value. Finally, the control module 112 divides the second calculated value by the third calculated value to obtain the average value. Accordingly, when the RSSI value of the broadcast signal Bs1 of the first communication channel is −55 and the RSSI value of the broadcast signal Bs2 of the second communication channel is −58, the average value is −56.125((-55×1.0 + -58×0.6) ÷ 1.6). The above mechanism can effectively increase the weight of stable communication channels and reduce the weight of less stable communication channels so as to improve calculation accuracy. The first variance threshold value, the second variance threshold value, and the weights may be adjusted according to actual requirements.

In addition, the control module 112 may determine whether a plurality of consecutive ranging results satisfy an adaptive adjustment condition according to an adaptive adjustment window. When consecutive ranging results are determined to satisfy the adaptive adjustment condition based on the adaptive adjustment window, the control module 112 dynamically adjusts the size of the sampling window W2 according to a fluctuation threshold value, a predetermined number of consecutive fluctuations, and a predetermined multiplier. For example, the control module 112 may dynamically increase the size of the sampling window W2 according to the fluctuation threshold value, the predetermined number of consecutive fluctuations, and the predetermined multiplier when the fluctuation between any two adjacent ranging results among the consecutive ranging results within the adaptive adjustment window exceeds the fluctuation threshold value (the adaptive adjustment condition). When the fluctuation between any two adjacent ranging results within the adaptive adjustment window exceeds the fluctuation threshold value, it indicates that environmental noise interference is severe. At this time, the control module 112 may increase the size of the sampling window W2 to improve accuracy. For example, the adaptive adjustment window is 3, the size of the sampling window W2 is 5 (5 RSSI values), the fluctuation threshold value is 1.5 meters, the predetermined number of consecutive fluctuations is 3, and the predetermined multiplier is 2. The control module 112 calculates the distance between the control module 112 and another IoT device 11 as 2 meters in a first calculation, 3.3 meters in a second calculation, and 1 meter in a third calculation. The difference between the second ranging result and the first ranging result is 1.3 meters, which is within the fluctuation threshold value (1.5 meters), whereas the difference between the third ranging result and the second ranging result is 2.3 meters, which exceeds the fluctuation threshold value (1.5 meters). At this time, the control module 112 increases the sampling window W2 to 10 (10 RSSI values). Accordingly, the above mechanism achieves an adaptive adjustment effect such that ranging becomes more accurate without requiring manual adjustment by the user. Therefore, the robustness of the IoT device 11 can be effectively improved. The adaptive adjustment window, the adaptive adjustment condition, the fluctuation threshold value, the predetermined number of consecutive fluctuations, and the predetermined multiplier may all be adjusted according to actual requirements.

The above optimized RSSI calculation mechanism can significantly improve calculation accuracy, enabling the IoT device 11 to accurately calculate the distance between itself and another IoT device 11 without being adversely affected by interference or contamination of the Bluetooth communication channel. Accordingly, the performance of the IoT device 11 can be significantly improved to satisfy the requirements of various applications.

In addition, the control module 112 continuously receives new broadcast signals, adds RSSI values of the new broadcast signals into the sampling window W2, removes the earliest RSSI value in the sampling window W2, and repeats the same calculation procedure. Accordingly, the control module 112 can continuously optimize calculation accuracy.

As described above, the IoT device 11 may be a lighting device or other devices with different functions, such as sensing devices (e.g., microwave sensing devices, infrared sensing devices and the like), or various household appliances. Therefore, the IoT device 11 can be applied to various intelligent applications, such as smart homes, smart factories, and smart parking systems, to provide various functions. Accordingly, the IoT device 11 can be comprehensive in application and more flexible in use.

In addition, the IoT device 11 has a simple design and can achieve the desired effects without increasing cost. Accordingly, the IoT device 11 has high practicability for various intelligent applications and conforms to future development trends.

The embodiment just exemplifies the disclosure and is not intended to limit the scope of the disclosure; any equivalent modification and variation according to the spirit of the disclosure is to be also included within the scope of the following claims and their equivalents.

It is worthy to point out that the currently available ranging approaches still suffer from various deficiencies. For example, Bluetooth communication channels are susceptible to significant channel interference and contamination. When a large number of other Bluetooth devices or other interference sources are present in the same communication channel, normal reception of the broadcast signals may be adversely affected, which may result in inaccurate measurement of the received signal strength indication. By contrast, according to one embodiment of the disclosure, an IoT device includes a Bluetooth module and a control module. The control module is connected to the Bluetooth module and switches the communication channel of the Bluetooth module based on a Bluetooth channel hopping mechanism, such that the Bluetooth module receives a plurality of broadcast signals from another IoT device over a plurality of communication channels. The control module calculates the received signal strength indication (RSSI) value of each of the broadcast signals, perform a filtering algorithm based on the RSSI values of the broadcast signals to obtain an updated RSSI value, and calculate the distance between the control module and another IoT device based on the updated RSSI value. Through the above optimized RSSI calculation mechanism, the IoT device can quickly calculate the distance between itself and another IoT device. Therefore, the IoT device can meet actual requirements.

Also, according to one embodiment of the disclosure, the IoT device has an optimized RSSI calculation mechanism. The control module performs the filtering algorithm to establish a filtering window and a sampling window greater than the filtering window, and processes the RSSI values of the broadcast signals according to the filtering window and the sampling window to obtain the updated RSSI value. When the RSSI values of the broadcast signals have not filled the sampling window, the control module calculates the average value of the RSSI values of the multiple broadcast signals, and then calculates the distance between the control module and another IoT device according to the average value. When the RSSI values of the broadcast signals fill the sampling window, the control module removes the maximum value and the minimum value of the RSSI values of the broadcast signals to obtain an updated data, calculates the average value of the updated data, and then calculates the distance between the control module and another IoT device according to the average value. The above optimized RSSI calculation mechanism can significantly improve calculation accuracy, enabling the IoT device to accurately calculate the distance between itself and another IoT device without being affected by interference or contamination of the Bluetooth communication channels. Therefore, the performance of the IoT device can be greatly improved to meet the requirements of different applications.

Further, according to one embodiment of the disclosure, the control module continuously receives new broadcast signals and adds RSSI values of the new broadcast signals into the sampling window. Meanwhile, the control module removes the RSSI value corresponding to the earliest time point in the sampling window and repeats the same calculation procedure. Accordingly, the control module can continuously optimize calculation accuracy.

Moreover, according to one embodiment of the disclosure, the IoT device may not only be a lighting device, but may also be various devices having different functions, such as sensing devices (e.g., microwave sensing devices, infrared sensing devices and the like), or various household appliances. Therefore, the IoT device can be applied to various smart applications, such as smart homes, smart factories, and smart parking lots, to provide various functions. Accordingly, the IoT device can be more comprehensive in application and more flexible in use.

Furthermore, according to one embodiment of the disclosure, the IoT device has a simple design and can achieve the desired effects without increasing cost. Accordingly, the IoT device can achieve high practicality in various smart applications. Therefore, the IoT device can meet future development trends. As described above, the IoT device with ranging capability according to the embodiments of the disclosure can indeed achieve excellent technical effects.

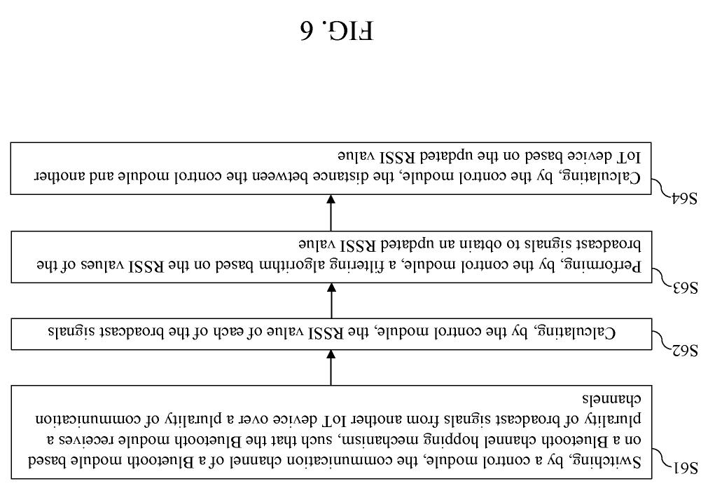

Please refer to FIG. 6, which is a flow chart of a ranging method for an IoT device in accordance with a second embodiment of the disclosure. As shown in FIG. 6, the ranging method of the IoT device in this embodiment includes the following steps:

Step S61: switching, by a control module, the communication channel of a Bluetooth module based on a Bluetooth channel hopping mechanism, such that the Bluetooth module receives a plurality of broadcast signals from another IoT device over a plurality of communication channels.

Step S62: calculating, by the control module, the RSSI value of each of the broadcast signals.

Step S63: performing, by the control module, a filtering algorithm based on the RSSI values of the broadcast signals to obtain an updated RSSI value.

Step S64: calculating, by the control module, the distance between the control module and another IoT device based on the updated RSSI value.

It should be understood that the present embodiment is provided for illustrative purposes only and is not intended to limit the scope of the present invention. Any equivalent modifications or variations made based on the ranging method of the IoT device of the present embodiment shall fall within the scope of the present invention.

Although the steps of the method of the present invention are illustrated and described in a particular order, the sequence of operations of each method may be changed, some steps may be performed in a reverse order, or some steps may be performed simultaneously with other steps. In another embodiment, different steps may be performed intermittently and or alternately.

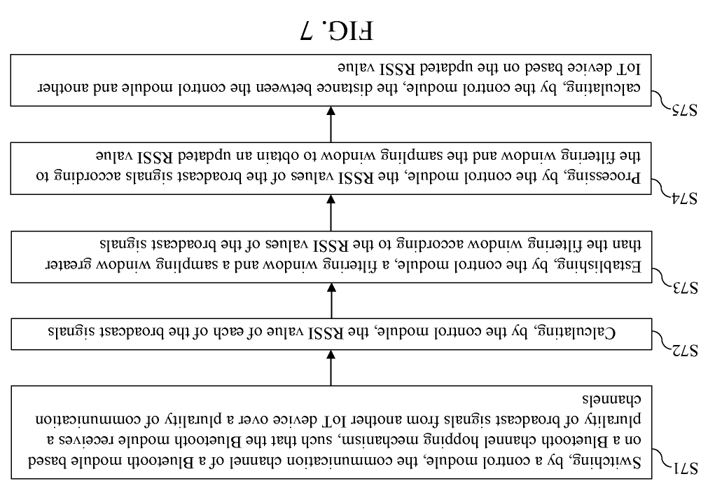

Please refer to FIG. 7, which is a flow chart of a ranging method for an IoT device in accordance with a third embodiment of the disclosure. As shown in FIG. 7, the ranging method of the IoT device in this embodiment includes the following steps:

Step S71: switching, by a control module, the communication channel of a Bluetooth module based on a Bluetooth channel hopping mechanism, such that the Bluetooth module receives a plurality of broadcast signals from another IoT device over a plurality of communication channels.

Step S72: calculating, by the control module, the RSSI value of each of the broadcast signals.

Step S73: establishing, by the control module, a filtering window and a sampling window greater than the filtering window according to the RSSI values of the broadcast signals.

Step S74: processing, by the control module, the RSSI values of the broadcast signals according to the filtering window and the sampling window to obtain an updated RSSI value.

Step S75: calculating, by the control module, the distance between the control module and another IoT device based on the updated RSSI value.

It should be understood that the present embodiment is provided for illustrative purposes only and is not intended to limit the scope of the present invention. Any equivalent modifications or variations made based on the ranging method of the IoT device of the present embodiment shall fall within the scope of the present invention.

Although the steps of the method of the present invention are illustrated and described in a particular order, the sequence of operations of each method may be changed, some steps may be performed in a reverse order, or some steps may be performed simultaneously with other steps. In another embodiment, different steps may be performed intermittently and or alternately.

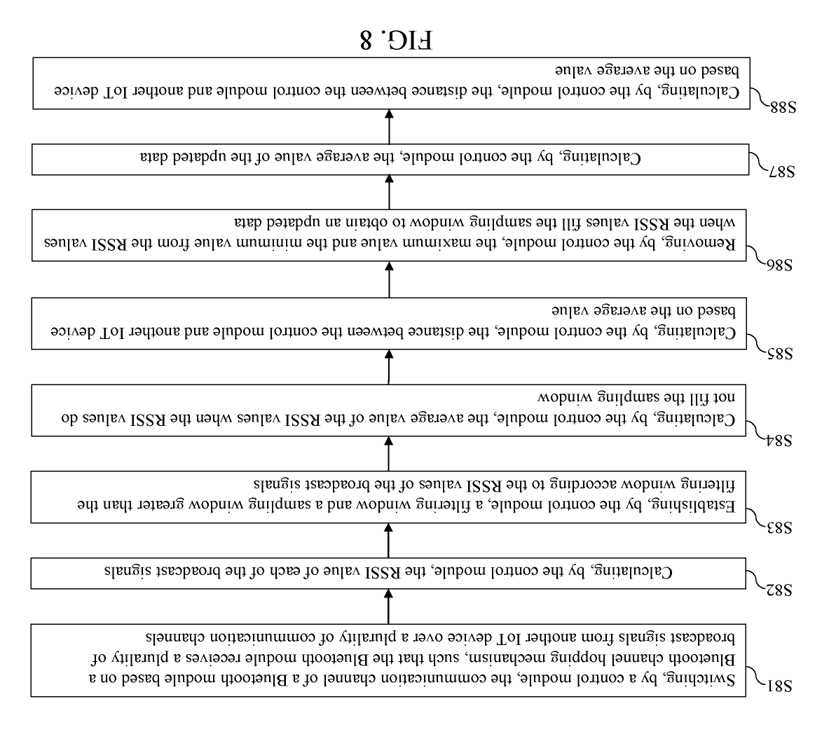

Please refer to FIG. 8, which is a flow chart of a ranging method for an IoT device in accordance with a fourth embodiment of the disclosure. As shown in FIG. 8, the ranging method of the IoT device in this embodiment includes the following steps:

Step S81: switching, by a control module, the communication channel of a Bluetooth module based on a Bluetooth channel hopping mechanism, such that the Bluetooth module receives a plurality of broadcast signals from another IoT device over a plurality of communication channels.

Step S82: calculating, by the control module, the RSSI value of each of the broadcast signals.

Step S83: establishing, by the control module, a filtering window and a sampling window greater than the filtering window according to the RSSI values of the broadcast signals.

Step S84: calculating, by the control module, the average value of the RSSI values when the RSSI values do not fill the sampling window.

Step S85: calculating, by the control module, the distance between the control module and another IoT device based on the average value.

Step S86: removing, by the control module, the maximum value and the minimum value from the RSSI values when the RSSI values fill the sampling window to obtain an updated data.

Step S87: calculating, by the control module, the average value of the updated data.

Step S88: calculating, by the control module, the distance between the control module and another IoT device based on the average value.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the disclosure, an IoT device includes a Bluetooth module and a control module. The control module is connected to the Bluetooth module and switches the communication channel of the Bluetooth module based on a Bluetooth channel hopping mechanism, such that the Bluetooth module receives a plurality of broadcast signals from another IoT device over a plurality of communication channels. The control module calculates the received signal strength indication (RSSI) value of each of the broadcast signals, perform a filtering algorithm based on the RSSI values of the broadcast signals to obtain an updated RSSI value, and calculate the distance between the control module and another IoT device based on the updated RSSI value. Through the above optimized RSSI calculation mechanism, the IoT device can quickly calculate the distance between itself and another IoT device. Therefore, the IoT device can meet actual requirements.

Also, according to one embodiment of the disclosure, the IoT device has an optimized RSSI calculation mechanism. The control module performs the filtering algorithm to establish a filtering window and a sampling window greater than the filtering window, and processes the RSSI values of the broadcast signals according to the filtering window and the sampling window to obtain the updated RSSI value. When the RSSI values of the broadcast signals have not filled the sampling window, the control module calculates the average value of the RSSI values of the multiple broadcast signals, and then calculates the distance between the control module and another IoT device according to the average value. When the RSSI values of the broadcast signals fill the sampling window, the control module removes the maximum value and the minimum value of the RSSI values of the broadcast signals to obtain an updated data, calculates the average value of the updated data, and then calculates the distance between the control module and another IoT device according to the average value. The above optimized RSSI calculation mechanism can significantly improve calculation accuracy, enabling the IoT device to accurately calculate the distance between itself and another IoT device without being affected by interference or contamination of the Bluetooth communication channels. Therefore, the performance of the IoT device can be greatly improved to meet the requirements of different applications.

Further, according to one embodiment of the disclosure, the control module continuously receives new broadcast signals and adds RSSI values of the new broadcast signals into the sampling window. Meanwhile, the control module removes the RSSI value corresponding to the earliest time point in the sampling window and repeats the same calculation procedure. Accordingly, the control module can continuously optimize calculation accuracy.

Moreover, according to one embodiment of the disclosure, the IoT device may not only be a lighting device, but may also be various devices having different functions, such as sensing devices (e.g., microwave sensing devices, infrared sensing devices and the like), or various household appliances. Therefore, the IoT device can be applied to various smart applications, such as smart homes, smart factories, and smart parking lots, to provide various functions. Accordingly, the IoT device can be more comprehensive in application and more flexible in use.

Furthermore, according to one embodiment of the disclosure, the IoT device has a simple design and can achieve the desired effects without increasing cost. Accordingly, the IoT device can achieve high practicality in various smart applications. Therefore, the IoT device can meet future development trends.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An internet of things (IoT) device with ranging capability, comprising:
a Bluetooth module; and
a control module connected to the Bluetooth module and configured to switch the Bluetooth module based on a Bluetooth channel hopping mechanism, whereby the Bluetooth module receives a plurality of broadcast signals from another IoT device over a plurality of communication channels;
wherein the control module is configured to calculate a received signal strength indication (RSSI) value of each of the broadcast signals, perform a filtering algorithm based on the RSSI values of the broadcast signals to obtain an updated RSSI value, and calculate a distance between the control module and the another IoT device based on the updated RSSI value.

2. The IoT device as claimed in claim 1, wherein the filtering algorithm comprises a moving average filtering algorithm, a median filtering algorithm, or a Kalman filtering algorithm.

3. The IoT device as claimed in claim 1, wherein the control module is configured to perform the filtering algorithm to establish a filtering window and a sampling window greater than the filtering window, and to process the RSSI values of the broadcast signals according to the filtering window and the sampling window to obtain the updated RSSI values.

4. The IoT device as claimed in claim 3, wherein when the RSSI values of the broadcast signals do not fill the sampling window, the control module is configured to calculate an average value of the RSSI values and calculate the distance between the control module and the another IoT device based on the average value.

5. The IoT device as claimed in claim 3, wherein when the RSSI values of the broadcast signals fill the sampling window, the control module is configured to remove a maximum value and a minimum value from the RSSI values to obtain updated data, calculate an average value of the updated data, and calculate the distance between the control module and the another IoT device based on the average value.

6. The IoT device as claimed in claim 3, wherein the control module is configured to determine whether a plurality of consecutive ranging results satisfy an adaptive adjustment condition according to an adaptive adjustment window, and the control module is configured to dynamically adjust a size of the sampling window according to a fluctuation threshold value, a predetermined number of consecutive fluctuations, and a predetermined multiplier when the consecutive ranging results are determined to satisfy the adaptive adjustment condition.

7. The IoT device as claimed in claim 1, wherein the control module is configured to adjust a ranging period and a hopping speed of the Bluetooth channel hopping mechanism according to a plurality of distance threshold values and the distance between the control module and the another IoT device.

8. The IoT device as claimed in claim 1, wherein the control module is configured to exclude, from the filtering algorithm, the RSSI value of the broadcast signal of any one of the communication channels when the RSSI value of the broadcast signal of the communication channel exceeds a variance threshold value.

9. A ranging method for an IoT device, comprising:
switching, by a control module, a Bluetooth module based on a Bluetooth channel hopping mechanism, whereby the Bluetooth module receives a plurality of broadcast signals from another IoT device over a plurality of communication channels;
calculating, by the control module, a received signal strength indication (RSSI) value of each of the broadcast signals;
performing, by the control module, a filtering algorithm based on the RSSI values of the broadcast signals to obtain an updated RSSI value; and
calculating, by the control module, a distance between the control module and the another IoT device based on the updated RSSI value.

10. The ranging method as claimed in claim 9, wherein the filtering algorithm comprises a moving average filtering algorithm, a median filtering algorithm, or a Kalman filtering algorithm.

11. The ranging method as claimed in claim 9, wherein a step of performing, by the control module, the filtering algorithm based on the RSSI values of the broadcast signals to obtain the updated RSSI value comprises:
establishing, by the control module, a filtering window and a sampling window greater than the filtering window; and
processing, by the control module, the RSSI values of the broadcast signals according to the filtering window and the sampling window to obtain the updated RSSI value.

12. The ranging method as claimed in claim 11, wherein a step of processing, by the control module, the RSSI values of the broadcast signals according to the filtering window and the sampling window to obtain the updated RSSI value comprises:
calculating, by the control module, an average value of the RSSI values when the RSSI values do not fill the sampling window; and
calculating, by the control module, the distance between the control module and the another IoT device based on the average value.

13. The ranging method as claimed in claim 11, wherein a step of processing, by the control module, the RSSI values of the broadcast signals according to the filtering window and the sampling window to obtain the updated RSSI value comprises:
removing, by the control module, a maximum value and a minimum value from the RSSI values when the RSSI values fill the sampling window to obtain an updated data;
calculating, by the control module, an average value of the updated data; and
calculating, by the control module, the distance between the control module and the another IoT device based on the average value.

14. The ranging method as claimed in claim 11, further comprises:
determining, by the control module, whether a plurality of consecutive ranging results satisfy an adaptive adjustment condition according to an adaptive adjustment window; and
dynamically adjusting, by the control module, a size of the sampling window according to a fluctuation threshold value, a predetermined number of consecutive fluctuations, and a predetermined multiplier when the consecutive ranging results are determined to satisfy the adaptive adjustment condition.

15. The ranging method as claimed in claim 9, further comprises:
adjusting, by the control module, a ranging period and a hopping speed of the Bluetooth channel hopping mechanism according to a plurality of distance threshold values and the distance between the control module and the another IoT device.

16. The ranging method as claimed in claim 9, further comprises:
excluding, by the control module, from the filtering algorithm, the RSSI value of the broadcast signal of any one of the communication channels when the RSSI value of the broadcast signal of the communication channel exceeds a variance threshold value.
